(19) United States
(12) Patent Application Publication
(10) Pub. No.: US 2021/0349556 A1
(43) Pub. Date: Nov. 11, 2021

(54) Double sided art stylus gaming wand

(71) Applicant: Natividad Daniel LeRoy Holliday, JR., San Francisco, CA (US)

(72) Inventor: Natividad Daniel LeRoy Holliday, JR., San Francisco, CA (US)

(21) Appl. No.: 16/873,576

(22) Filed: May 5, 2020

(51) Int. Cl. G06F 3/0354; B32B 1/00; B32B 21/08

(52) U.S. Cl. CPC G06F 3/03545; B32B 2457/00; B32B 21/08; B32B 1/00

(57) ABSTRACT

Input hardware device responds to computer technology, is haptic compliant with any touchscreen surface and physically simulated with offline usage all local and global networks. The Gaming Wand is so light weight, like 95% bamboo wood, 4% metallic thin sheet, and 1% polyester coating makes it 99% environmentally safe, and 99% biodegradable; the polyester coating part is not biodegradable. It's made up of Simple Items: bamboo, and Mylar tape/skin wrapped around the bamboo rod. Just tap, type, and/or swipe on your any Smartphone device no matter how you pick it up. The outlandish uses of this input hardware device is universal when it comes to the Tech World for touchscreen devices' spirit, compassion, and goodwill. This invention as a whole may be provided by using some, or all of the mentioned features, and pieces without leaving from the spirit of the invention, and scope of the patent of the present invention. The realization described above are specific examples of a single broader invention, which may have greater scope than any of the singular descriptions prepared. Changes may be made in the descriptives without leaving from the spirit of the invention, and scope of the patent of the spirit and scope of the present invention. My contribution to society is suitable for the future of technology, and leisure time. I am taking charge of the entitlement to defend the invention.

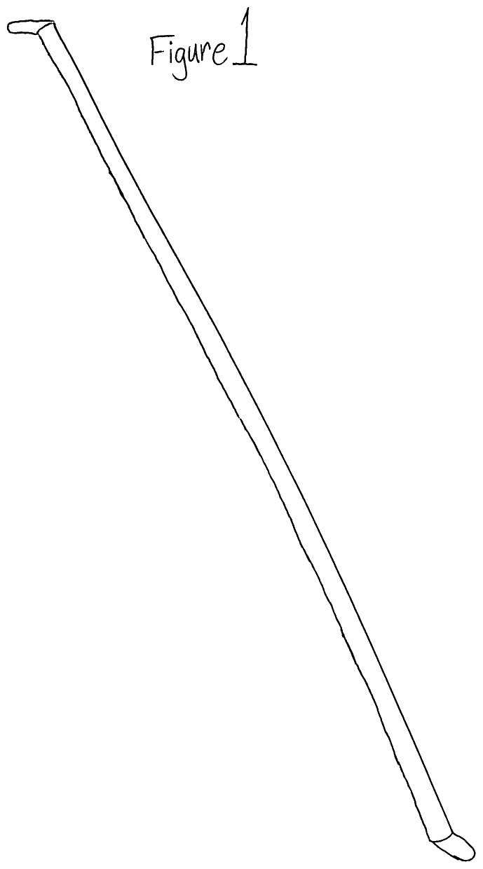

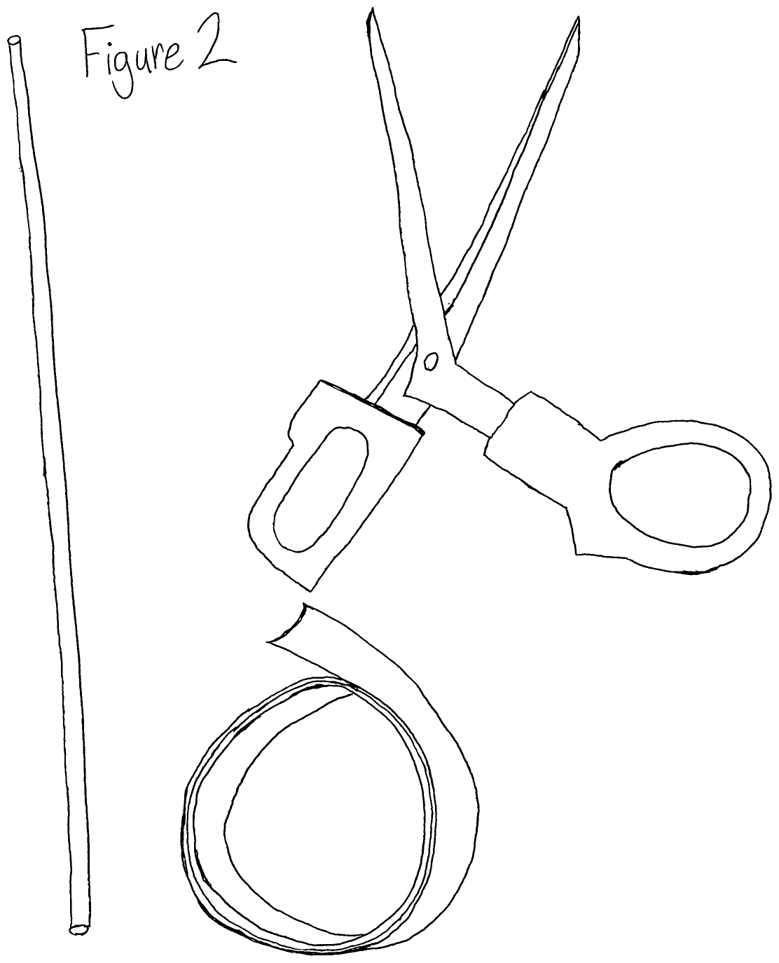

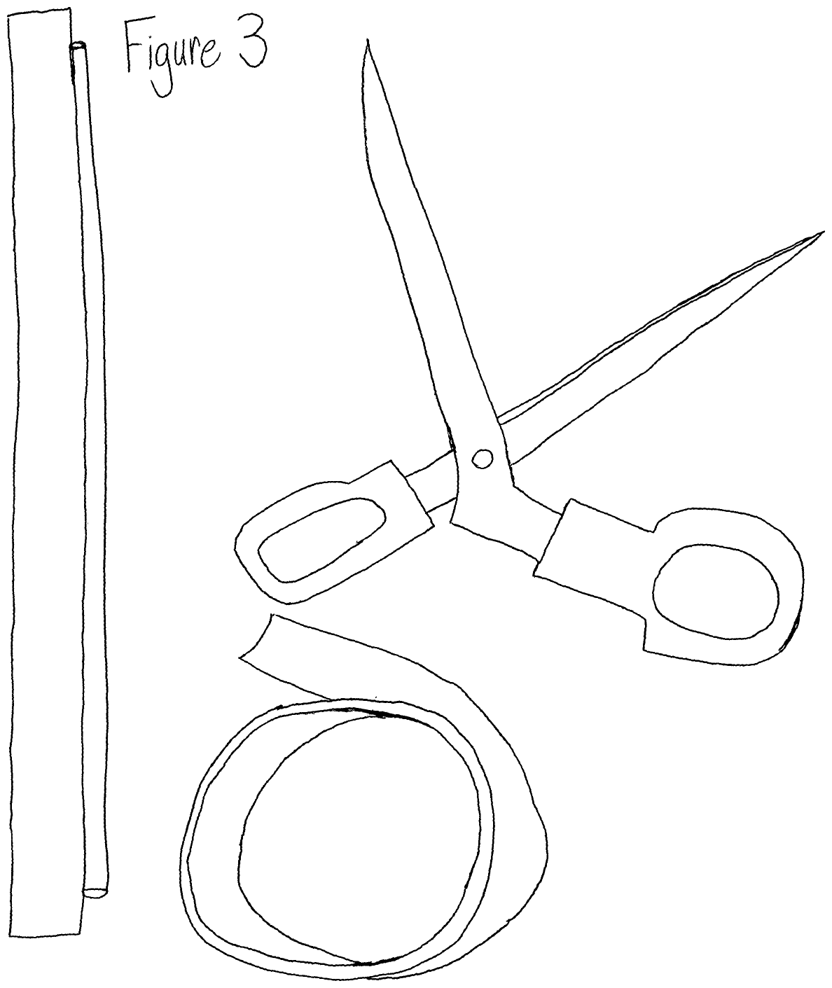

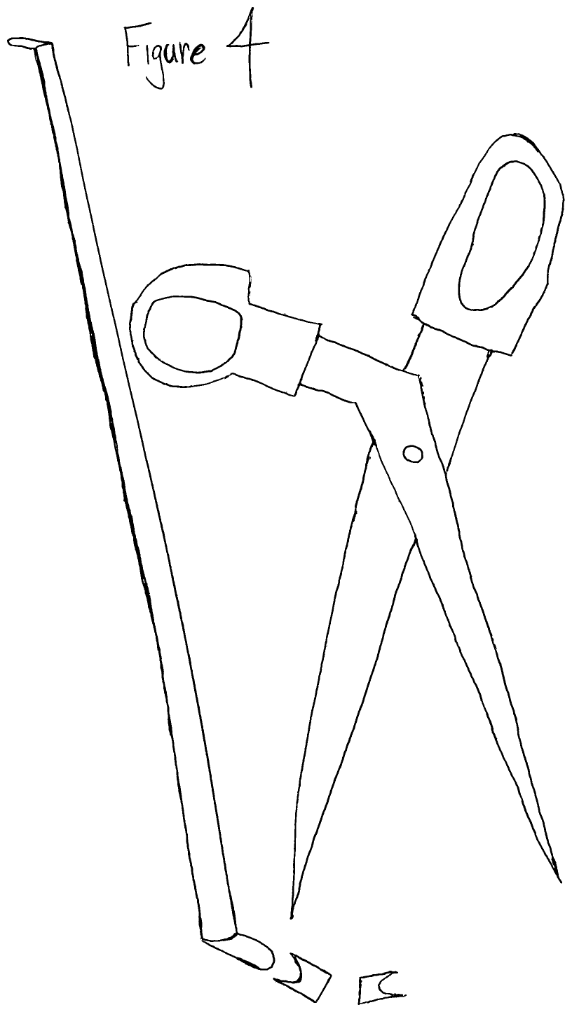

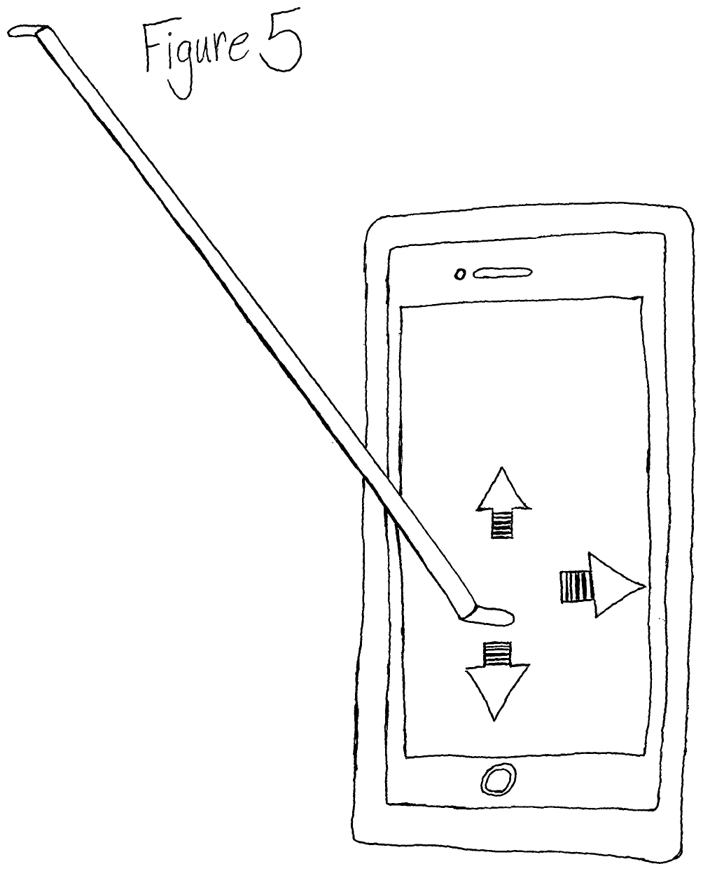

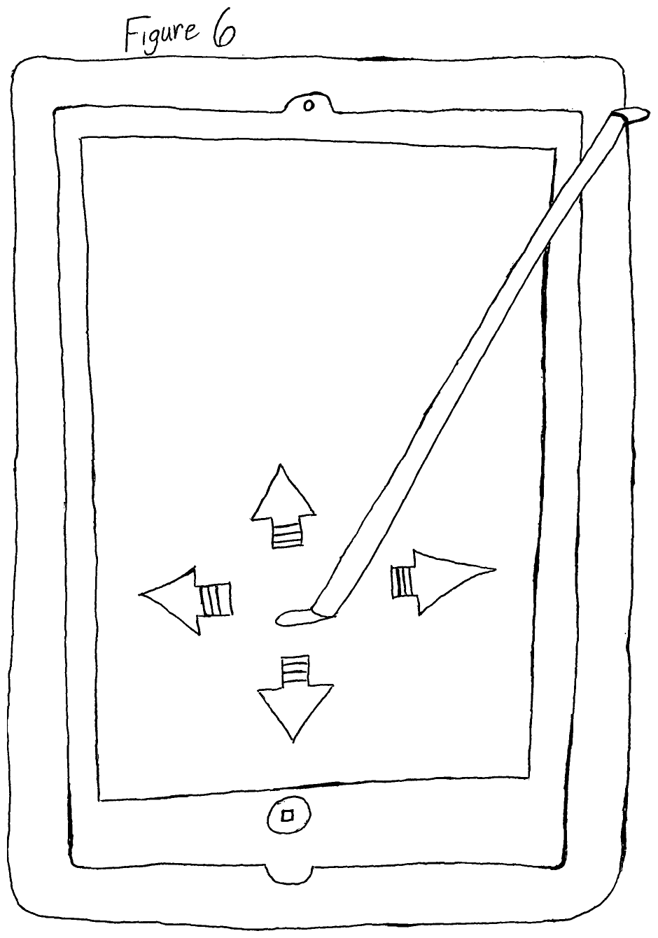

The Doubled Sided Art Stylus Gaming Wand is the simplest form of Input Hardware that help the consumer tap, type, and/or swipe on any touchscreen device.

### BRIEF SUMMARY OF THE DOUBLE SIDED ART STYLUS GAMING WAND

Just pick-up the input hardware device, and tap, type, and/or swipe the Gaming Wand across any touchscreen device.

### DOUBLE SIDED ART STYLUS GAMING WAND'S BRIEF DESCRIPTION OF THE DRAWINGS

The drawings of the Double Sided Art Stylus Gaming Wand shows anyone, or the consumer how the device is made in Figure B, Figure C, and Figure D. Figure E, and Figure F shows how to use the Gaming Wand properly. It's so simple to play with, just tap, type, and/or swipe.

### DETAILED DESCRIPTION OF THE DOUBLE SIDED ART STYLUS GAMING WAND

The Double Sided Art Stylus Gaming Wand is made from bamboo, and Mylar tape/skin. The Mylar tape/skin is wrapped around the bamboo creating a device that is universal to any touchscreen surface, or any touch key. The usage of the Gaming Wand is by tapping, typing, and/or swiping on any device acquired.

I claim:

1. The Double Sided Art Stylus Gaming Wand comprising of a bamboo frame, and Mylar tape/skin wrapped around the bamboo; and all its addendums to create input hardware for the vast technology world of touchscreen and key surfaces; and all of the invention's addendums.

2. The Double Sided Art Stylus Gaming Wand (D.S.A.S.G.W.), the Wand, is made of 2 simple items: bamboo, and Mylar tape/skin; in which the Mylar tape/skin is wrapped around the bamboo to make its form, and all of the invention's addendums.

3. The Double Sided Art Stylus Gaming Wand (D.S.A.S.G.W.) sizes are from 1″ (inch) to 5′ (feet) to be reasonable; the most common sizes in use are around: 5¼″, 9¾″, and 12″ inches; although the bamboo is cut at 4″, 9″, and 11″inches, the non-scratch ends/tips (¼″ of an inch to 1″ inch in length) fill in the rest of the form of the invention, and all of the invention's addendums.

4. The Double Sided Art Stylus Gaming Wand (D.S.A.S.G.W.), uses bamboo rods that are very strong wood, and light weight; which includes any size frame that can be made of various materials also, as well, and all of its light weight addendums like metal rod gage thickness/sizes from 0 to 31, carbon string with carbon resin to make with sturdiness, or hardness of the base inside that the metallized tape wraps around; and all of the invention's addendums.

5. The Double Sided Art Stylus Gaming Wand (D.S.A.S.G.W.), works on both sides of its entitlement; no matter how you pick the Wand up, it's ready to use; and all of the invention's addendums.

6. Strength to activate any touchscreen surface device like: iPhone, iPad, Smartphone, or Tablet menu's, Apps, and keyboard to type with the Double Sided Art Stylus Gaming Wand (D.S.A.S.G.W.); and all of the invention's addendums.

7. The Double Sided Art Stylus Gaming Wand (D.S.A.S.G.W.), helps the touchscreen pick up the input/output frequency to activate the touchscreen sensor which is the radio-frequency identification sensors and senders touch sensitivity, and all of the invention's addendums.

8. The Double Sided Art Stylus Gaming Wand (D.S.A.S.G.W.), has scratch proof tips, or ends which perform on a touchscreen surface that's especially made for online drawing/painting Apps (Artists need more arm and elbow room to draw, sketch, illustrate, paint, and et cetera; also making different sizes particularly for the cause of creating art), and all of the invention's addendums.

9. The Double Sided Art Stylus Gaming Wand (D.S.A.S.G.W.), has a metallic shine so you don't easily misplace it (real easy to find); and all of the invention's addendums.

10. The Double Sided Art Stylus Gaming Wand (D.S.A.S.G.W.), is made from metallized tape/skin that can detect/sensor the multi-function screen on any Smartphone, Tablet, and/or any multi-screen touch device; and can be any color of metallic tape pattern designs of the device made is available in the metallized tape printed domain (Black, Green, Red, Blue, Bronze, Silver, and Gold, and et cetera); and all the invention's addendums.

11. The Double Sided Art Stylus Gaming Wand (D.S.A.S.G.W.), activates input and output touchscreen sensors on device surfaces with radio frequency identification sensors and senders that detect the screen normality layered on the top of an electric visual display of an information processing system, and all of the invention's addendums.

12. The Double Sided Art Stylus Gaming Wand is conductive enough to replace anyone's finger on any touchscreen device, and all of the invention's addendums.

13. The Double Sided Art Stylus Gaming Wand (D.S.A.S.G.W.), is a multi-touch receptor, controller-based firmware, input hardware, and all of the invention's addendums.

14. The Double Sided Art Stylus Gaming Wand (D.S.A.S.G.W.), detects the 2 thin flexible metallic layers with an electric current flowing through a small gap; when you tap, type, and/or swipe the top flexible layer of the screen, the D.S.A.S.G.W. pushes down on, and touches the bottom layer, and interrupting the current flow; just tap, type, and/or swipe on any touchscreen device; and all of the invention's addendums.

15. The Double Sided Art Stylus Gaming Wand (D.S.A.S.G.W.), commands on screen details by tapping, typing, and/or swiping; and all of the invention's addendums.

16. The Double Sided Art Stylus Gaming Wand (D.S.A.S.G.W.), is 99% biodegradable, which makes it environmentally friendly, environmentally safe, and light weight (Not a struggle to use), so light weight that it's lighter than a pen, or pencil, and all of the invention's addendums.

17. The Double Sided Art Stylus Gaming Wand (D.S.A.S.G.W.), is my versions of what is called the Stylus (tech slang); and all of the invention's addendums.

18. The Double Sided Art Stylus Gaming Wand (D.S.A.S.G.W.), works on both sides of its entitlement; no matter how you pick the wand up it's ready to use; and all of the invention's addendums.

19. The Double Sided Art Stylus Gaming Wand (D.S.A.S.G.W.), is completely safe to use if you Do Not stick the Gaming Wand in your ears, mouth, up your nose, in your eyes, up your innards, and/or et cetera.

20. The Double Sided Art Stylus Gaming Wand (D.S.A.S.G.W.), requires: no batteries, no syncing, no smoke, no mirrors, no plugs, no cords, no Bluetooth connection, no Wi-Fi connection, and et cetera; and all of the invention's addendums.
